(19) United States
(12) Patent Application Publication
(10) Pub. No.: US 2026/0172338 A1
(43) Pub. Date: Jun. 18, 2026

(54) SDWAN SELF-CONTAINED TEST BASED ON BUILT-IN DIA AND NETWORK-WIDE BIDIRECTIONAL PCAP REPLAY

(71) Applicant: Cisco Technology, Inc., San Jose, CA (US)

(72) Inventors: Xiaorong Wang, Shanghai (CN); Wei Zhou, Changsha (CN); Xin Qu, Shanghai (CN); Chang Zhao, Hangzhou (CN); Jianda Liu, Shanghai (CN); Yicheng Liu, Shanghai (CN); Si Shi, Shanghai (CN)

(21) Appl. No.: 19/066,986

(22) Filed: Feb. 28, 2025

Related U.S. Application Data
(60) Provisional application No. 63/733,860, filed on Dec. 13, 2024.

(51) Int. Cl. H04L 43/50; H04L 43/02; H04L 43/20

(52) U.S. Cl. CPC H04L 43/50; H04L 43/02; H04L 43/20

(57) ABSTRACT

Mimicking user traffic through components of a network to facilitate network and data testing is provided. A PCAP file for a captured data stream is generated. A test request may include testing data contained in the PCAP file via a standalone Direct Internet Access (DIA) single router or via a network-wide site-to-site environment. The data contained in the PCAP file may be routed from a PCAP replay client to the PCAP replay server both at a single router or may be routed to the PCAP replay server at a second router via a virtual private network (VPN). After the data contained in the PCAP file is routed to the PCAP replay server, the data contained in the PCAP file is routed from the PCAP replay server back to the PCAP replay client for bidirectional ping-pong interaction. A report of the processing of the PCAP file may be generated.

### CROSS-REFERENCE TO RELATED APPLICATION

This application claims priority to U.S. Provisional Application No. 63/733,860, filed Dec. 13, 2024, titled “SDWAN SELF-CONTAINED TEST BASED ON BUILT-IN NETWORK-WIDE BIDIRECTIONAL PCAP REPLAY,” the entirety of which is hereby incorporated by reference.

### TECHNICAL FIELD

The present disclosure relates generally to testing the operation of one or more components of a computing and/or communications network. More particularly, techniques and mechanisms of the present disclosure relate to mimicking user traffic through components of a network to facilitate network testing, trouble shooting, network design/pre-test, and network implementation.

### BACKGROUND

Computing systems and communications systems networks are utilized by a wide range of users from individual users to large multi-national organizations. A typical user whether an individual user or organization of varying sizes may generate, utilize, and transport data from a variety of computing systems across one or more communications networks to a variety of intermediary or endpoint systems or recipients. For example, an individual user or small business may operate on-premises computing systems that provide services such as data processing, electronic mail, business management systems, equipment automation systems, and the like. Data from such systems may be transported locally among users'computing systems (e.g., electronic mail from a laptop computer to an electronic mail server or processing data from equipment automation systems to a central quality control application, and the like). Large organizations, for example, large businesses, social networking systems, education systems, and the like may transport data locally among local area networks or across complex wide area networks (e.g., data from multiple locations of a large business to a central data processing hub).

Data transmitted via a network from one application or system to another application or system is typically broken into data packets which are small pieces or fragments of a data transmission. It is often desirable to analyze data transmissions to detect data packet loss, to determine how one or more network components is/are processing data packets, and/or to determine whether undesirable data is included in a given data transmission that may be associated with a security concern for the network or for users of the network. Loss of data packets during data transmission causes a number of problems, for example, in the case of data transmission associated with communications applications or systems, packet loss may create connectivity issues such as disrupted audio, dropped calls, video distortion or jitter, static, and the like. In the case of network functionality, a given network component such as a switch or router may not be functioning properly, and such network functionality problems may cause loss or corruption of data packets. In the case of network security, malicious activity included in a data transmission may be detected in one or more data packets.

To test data transmission via a network or one or more components of a network, synthetic data traffic may be passed through the network or components of the network. One test method includes use of a network probe which may include analysis of network traffic by sending test data packets to various network components to measure network performance. However, program traffic is mostly for Internet/cloud service probes which requires Internet access to an associated network-enabled service, and it is difficult to create the same environment as is experienced by a user of the network and the associated network-enabled service. Another test method includes use of captured data packets in the form of a packet capture (PCAP) test that involves capture of data packets passing through components of a network. According to this method, the test environment setup and maintenance is quite complicated, especially in a production network, and once user traffic is captured during issue analysis, it is difficult to enable a traffic generation environment in a production network to reproduce and analyze issues by replaying the problematic traffic with user traffic intact.

### BRIEF DESCRIPTION OF THE DRAWINGS

The detailed description is set forth below with reference to the accompanying figures. In the figures, the left-most digit(s) of a reference number identifies the FIG. in which the reference number first appears. The use of the same reference numbers in different figures indicates similar or identical items. The systems depicted in the accompanying figures are not to scale and components within the figures may be depicted not to scale with each other.

FIG. 1 illustrates a system architecture for a computing and communications network, according to examples of the present disclosure.

FIG. 2 illustrates a system architecture for mimicking user traffic through components of a network via a direct Internet access (DIA) data transport to facilitate network testing, trouble shooting, network design/pre-test, and network implementation.

FIG. 3 illustrates a system architecture for mimicking user traffic through components of a network via a network-wide site-to-site data transport to facilitate network testing, trouble shooting, network design/pre-test, and network implementation.

FIG. 4 illustrates a flow diagram of an example method for mimicking user traffic through components of a network via a direct internet access (DIA) data transport or via a network-wide site-to-site data transport to facilitate network testing, trouble shooting, network design/pre-test, and network implementation.

FIG. 5 illustrates a flow diagram of an example method for mimicking user traffic through components of a network to facilitate network testing, trouble shooting, network design/pre-test, and network implementation.

FIG. 6 illustrates a flow diagram of an example method for mimicking user traffic through components of a network to facilitate network testing, trouble shooting, network design/pre-test, and network implementation.

FIG. 7 is a computer architecture diagram showing an illustrative computer hardware architecture for implementing a computing system/device that can be utilized to implement aspects of the various technologies presented herein.

### DESCRIPTION OF EXAMPLE EMBODIMENTS

### Overview

The present disclosure relates generally to testing the operation of one or more components of a computing and/or communications network. More particularly, techniques and mechanisms of the present disclosure relate to mimicking user traffic through components of a network to facilitate network testing, trouble shooting, network design/pre-test, and network implementation.

A method to perform techniques described herein may include mimicking user traffic through components of a network to facilitate network testing, trouble shooting, network design/pre-test, and network implementation. A request is received to test a captured data stream. A request is received to test a captured data stream includes receiving a request to test the captured data stream via a standalone Direct Internet Access (DIA) single router. Alternatively, receiving a request to test a captured data stream includes receiving a request to test the captured data stream via a network-wide site-to-site environment. The PCAP replay client is located at a first router within the network-wide site-to-site environment, and the PCAP replay server being located at a second router within the network-wide site-to-site environment. Routing network data packets and network data flows the PCAP file from the PCAP replay client to the PCAP replay server includes routing network data packets and network data flows the PCAP file from the PCAP replay client to the PCAP replay server via a virtual private network (VPN). After network data packets and network data flows the PCAP file is routed to the PCAP replay server, the network data packets and network data flows PCAP file is routed from the PCAP replay server back to the PCAP replay client. According to examples, the data contained in the PCAP file includes network data packets and network data flows parsed from the PCAP file by reading the PCAP file. Hereafter, network data packets and network data flows contained in the PCAP file will be referred to as “data contained in the PCAP file” for purposes of brevity.

According to examples, a packet capture (PCAP) file containing the captured data stream is generated. The data contained in PCAP file is tagged with one or more routing instructions. Tagging data contained in the PCAP file with one or more routing instructions includes tagging data contained in the PCAP file with an Internet Protocol (IP) address associated with the router based PCAP replay client. Tagging data contained in the PCAP file with one or more routing instructions includes tagging data contained in the PCAP file with an IP address associated with the PCAP replay server. The PCAP server being co-located with the router based PCAP replay client.

The data contained in PCAP file is routed to a router based PCAP replay client based on the one or more routing instructions. The data contained in PCAP file is received at the router based PCAP replay client. At the router based PCAP replay client, the data contained in the PCAP file is read, and routing instructions are determined for data contained in the PCAP file. The data contained in PCAP file is routed from the PCAP replay client to a PCAP replay server. Determining routing instructions for the PCAP file includes determining an IP address associated with the PCAP replay server. After routing data contained in the PCAP file from the PCAP replay client to the PCAP replay server, data contained in the PCAP file is received at the PCAP replay server.

A report is generated describing a result of routing data contained in the PCAP file from the PCAP replay client to the PCAP replay server. Generating a report describing a result of routing data contained in the PCAP file from the PCAP replay client to the PCAP replay server includes generating a report describing a condition of data contained in the PCAP file after data contained in the PCAP file is routed from the PCAP replay client to the PCAP replay server. Generating a report describing a result of routing data contained in the PCAP file from the PCAP replay client to the PCAP replay server includes generating a report at a test application.

A further method to perform the techniques described herein may include mimicking user traffic through components of a network to facilitate network testing, trouble shooting, network design/pre-test, and network implementation. A packet capture (PCAP) file is generated containing a captured data stream from a prior data operation. The data contained in the PCAP file is routed to a PCAP replay client at a network router. According to examples, the PCAP replay client and the PCAP replay server are co-located at the network router. Alternatively, the PCAP replay client is located at a first network router and the PCAP replay server is located at a second network router, and the PCAP replay client is in communication with the PCAP replay server from the first network router to the second network router via a virtual private network (VPN).

Prior to routing data contained in the PCAP file to a PCAP replay client at a network router, data contained in the PCAP file is tagged with one or more routing instructions. The data contained in the PCAP file is routed to a PCAP replay client at a network router based on the one or more routing instructions. The data contained in the PCAP file is routed from the PCAP replay client to a PCAP replay server based on the one or more routing instructions. According to examples, the data contained in the PCAP file is routed to a PCAP replay client at a network router based on the one or more routing instructions includes routing the data contained in the PCAP file to the PCAP replay client based on an Internet Protocol (IP) address associated with the PCAP replay client, and the data contained in the PCAP file is routed from the PCAP replay client to the PCAP replay server based on the one or more routing instructions includes routing the PCAP file to the PCAP replay server based on an IP address associated with the PCAP replay server.

The data contained in the PCAP file is processed at the PCAP replay client according to the prior data operation. After processing the data contained in the PCAP file at the PCAP replay client, the processed data contained in the PCAP file is routed to a PCAP replay server. The processed data contained in the PCAP file is processed according to the prior data operation. A report is generated describing a result of processing the data contained in the PCAP file at the PCAP replay client and at the PCAP replay server according to the prior data operation.

Additionally, the techniques described herein may be performed by a network component (e.g., a network router) having non-transitory computer-readable media storing computer-executable instructions that, when executed by one or more processors, performs the methods described above.

### EXAMPLE EMBODIMENTS

As briefly discussed above, computing systems and communications systems networks are utilized by a wide range of users. Local, wide area, on-premises and cloud-based networks are used for a great variety of computing and communications services. For example, users ranging from individual users to small businesses to large multi-national organizations use networking systems for communications, data entry and data processing for a wide range of services. Networking may be enabled by a networking service, for example, a telecommunications services provider, Internet services provider, and the like. Networks provided by such services providers may be configured in a number of ways. For example, a network may be configured that hosts a single user or a network may be configured that hosts a number of users. In the latter case, a network may be comprised of a number of computing and communications systems that are connected via one or more switches and routers that ensure data is transported to and from the various computing systems and communications systems on behalf of the user. For example, a given user may be associated with electronic mail systems, databases, security systems, and the like.

In order to test newly designed and implemented and/or existing network systems, synthetic traffic may be utilized to mimic user traffic to facilitate trouble shooting, network design/pre-test, zero touch onboarding of new sites/services without the need for extensive work from network personnel to set up a network environment. According to examples, various methods may be employed for testing newly designed and implemented and/or existing network systems. According to a first method, a probe may be employed. Multiple probes may be defined to generate synthetic domain name system (DNS) and Hypertext Transfer Protocol Secure (HTTPS) traffic for specified Domains/URLs to simulate user traffic for a Network-Wide Path Insights (NWPI) trace to provide insight for proof of concept (POC) or network and policy design validation. However a probe approach is primarily used for Internet/cloud services which requires Internet access to the service. It is difficult to create a same environment as experienced by users, and it is difficult to generate the same data traffic used and/or generated by users.

According to a second method, PCAP replay tools may be used as a data traffic generator and are used to replay PCAP files to simulate user data traffic (stateless or stateful). Users can set up a Software-Defined Wide Area Network (SD-WAN) topology with local and peer sites and a host with interfaces connected to both local and remote site Local Area Network (LAN) ports as client and server side ports to run the replay tools for bi-directional flow traffic. However, set up and maintenance for such test environments is complicated, especially in production networks. In addition, it is difficult to enable traffic generation environments in production networks to reproduce and triage issues by replaying the problematic traffic with user traffic intact.

According to examples of the present disclosure, the techniques and mechanisms described herein provide for a self-contained test with locally generated and consumed replay traffic on a local site or consumed by a remote site within a network fabric, e.g., a virtual private network (VPN) fabric based on a replayed data flow metadata tagging over the network fabric without external network or server node dependency or impact. SD-WAN self-contained test based on in-built network-wide bidirectional PCAP replay. As described in detail below, according to an example Direct Internet Access (DIA) self-contained test method, a PCAP replay is performed using a bidirectional client/server replay of a PCAP file where both the client and server functionality is performed “on box” on a single router such that testing of a replay of the PCAP file is performed by interaction between the client and server without leaving the confines of the router. As such, user traffic as captured in the PCAP file is used for the replay so that self-contained processing of the replay via the PCAP file mimics the user traffic as it would run from a client application, service or network resource to a server separate from the client. In order to process the PCAP file, the data contained in the PCAP file is tagged with metadata that designates the Internet protocol (IP) address of the client and server functionality resident on the single router.

After the data contained in the PCAP file is thus tagged, a network management system distributes the tagged PCAP file to either the client or server functionality operating in the control plane of the router, and the bidirectional replay may proceed between the client and server functionality to mimic client and server processing of the data contained in the PCAP file. According to examples, the data contained in the PCAP file will be indexed as client and server side messages based on byte sequence offset. As a result, ping-pong interaction between client and server side packets are triggered between LAN and DIA interfaces of the local site (router). A Network-Wide Path Insight (NWPI) trace may be automatically invoked to monitor and trace the replayed data flows of the replayed PCAP file to provide SD-WAN insight for proof of concept (POC), issue triage (e.g., data packet loss or malicious/undesired data) or network and policy design validation.

According to additional examples, a network-wide bidirectional stateful PCAP replay is provided with a distributed replay node client/server ping-pong interaction for a same PCAP file indexed as client and server side messages based on a byte sequence offset. As with the DIA case, the data contained in the PCAP file will be indexed as client and server side messages based on byte sequence offset, and the ping-pong interaction between client and server side packets are triggered between the local site (router) LAN interface and a remote site (remote router) LAN/DIA interface. Also, as with the DIA case, a Network-Wide Path Insight (NWPI) trace may be automatically invoked to monitor and trace the replayed data flows of the replayed PCAP file to provide SD-WAN insight for proof of concept (POC), issue triage (e.g., data packet loss or malicious/undesired data) or network and policy design validation.

Processing of data contained in the PCAP files, as described herein, may allow for both stateless and stateful processing. For stateless processing, the PCAP file is used to replay the same data traffic as captured from the user. During processing, the packet order of the PCAP file is replayed one by one. The same Transmission Control Protocol (TCP) flags, TCP options, packet sequence numbers, Maximum Segment Size (MSS) information, etc. for the user's captured data (captured in the PCAP file) is maintained so that use of the PCAP file will mimic processing of the user's data.

For stateful processing, IOS-XE system socket may be used (i.e., for TCP, to establish real TCP connection between the source and destination with MSS support) to replay the PCAP file. Data payload is extracted from the PCAP file packets and is written into the corresponding sockets. According to examples, a TCP stack will negotiate the MSS and do retransmission if packets are dropped. Each data flow in a used PCAP file will be replayed according to intervals (e.g., every minute) until the NWPI trace stopped.

According to User Datagram Protocol (UDP) flow, the same port may be used as used in the PCAP file. For a TCP flow, the same port may be used as in the PCAP file at a first-time replay. Starting from a second-time replay, TCP client-side port may be replaced with a valid dynamic port (ephemeral port) which may not be the same as the client port in PCAP file, and the server side port will be maintained.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

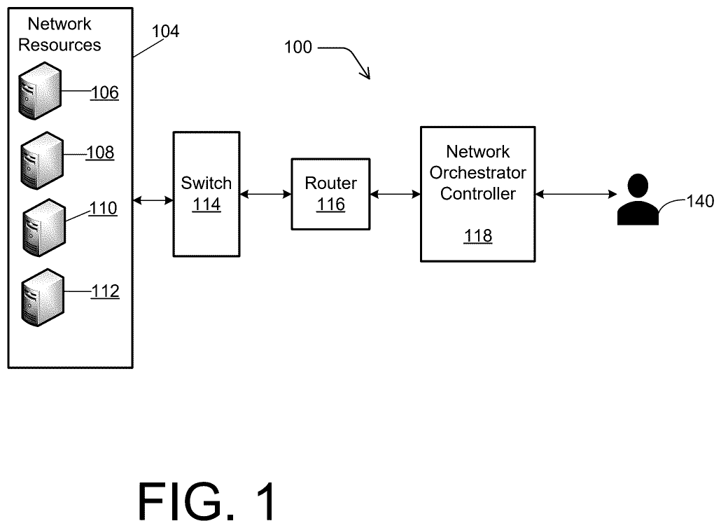

FIG. 1 illustrates a system architecture for a computing and communications network, according to examples of the present disclosure. According to examples, the network 100 is illustrative of an on-premises or cloud-based system with which computing services and communication services may be provided to one or more users 140 as described herein. The users 140 are representative of one or more users for which network services of the network 100 may be provided by a services provider, for example, a telecommunications or Internet services provider. For example, a given user 140 may represent one or more individual users, or one or more user entities such as businesses or other organizations of varying sizes from small organizations to large multi-national organizations. As should be appreciated, tens, hundreds, thousands or more users 140 may utilize services via the network 100, as described herein.

The network 100 is illustrative of a Local Area Network (LAN) that may operate in a user facility such as a home, place of business or campus of facilities. Alternatively, the network 100 may be illustrative of a Wide Area Network where components of the network 100 are distributed across varying distances and where the components of the network 100 communicate with each other via a telecommunications or Internet services provider. The network 100 may be provided by a services provider, for example, a telecommunications services provider, an Internet services provider, or the like. According to examples, one or more computing devices or systems 104 may be provided on-premises or cloud-based with which a user 140 may perform data processing and communications actions. The computing devices or systems 104 may include one or more computing applications, services or network resources 106, 108, 110, 112 with which computing and/or communications actions may be accomplished by and/or for the user 140. For example, the computing devices or systems 104 (106-112) may include electronic mail applications and servers, databases, data and communications security systems, equipment control systems, and the like. The computing devices or systems 104 (106-112) may also include peripheral devices such as printers, wireless access points, personal computing devices, and the like that are connected and operable via the network 100.

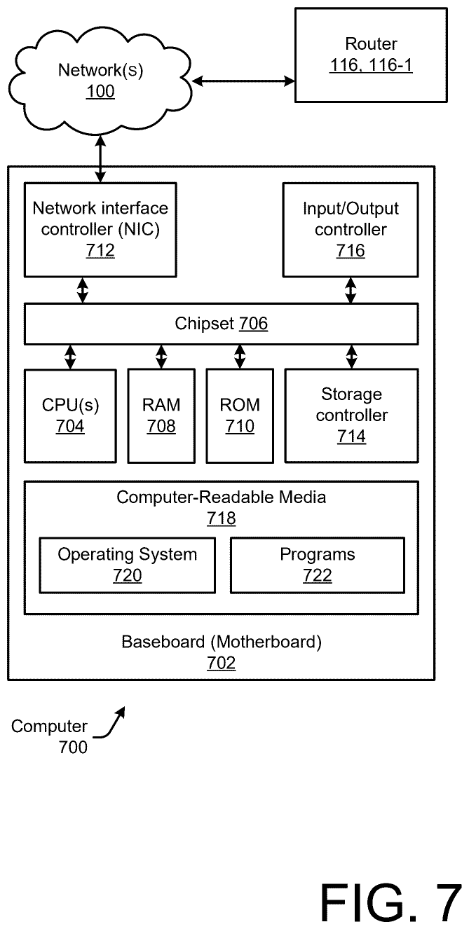

Each of the computing devices or systems 104 (106-112) may be separate physical devices, each of the computing devices or systems 104 (106-112) may be combined and may operate as a single computing device, service or network resource. Components and attributes of computing devices or systems 104 (106-112) are described below with reference to FIG. 7. Alternatively, one or more of the computing devices or systems 104 (106-112) may be configured as virtual computing systems operated via one or more physical computing devices or systems 104 (106-112). In such a configuration, each virtual computing system may provide a type of functionality, for example, electronic mail services, database services, or the like as a virtual system in the same manner as each of such systems may be provided via a dedicated physical system or device such as an electronic mail or database server.

Referring still to FIG. 1, the switch 114 is illustrative of a device or application responsible for connecting network devices such as the computing devices or systems 104 (106-112) to each other or to other systems within the network 100 or two computing systems or devices outside the network 100 other networks. The router 116 is illustrative of a device or application that connects different computing systems and devices to allow those systems and devices to communicate with other computing systems from one location to another across a telecommunications system or the Internet. According to examples, the router 116 may include at least one processor, as illustrated and described below with reference to FIG. 7, for executing programming instructions provisioned on the router 116, as described herein. The router 116 may connect computing systems and devices to create local networks of systems and devices that may operate in a single location (e.g., a home, building or facility), or the router may connect computing systems and devices to create large networks that may operate across locations (e.g., from one city to another city). According to examples, the systems, methods described herein operating via the router 116 may be operated via the switch 114 or similar network device or system. According to one example, the functionality of the router 116 and the switch 114 may operate via a single network device that includes the functionality of both the switch 114 and the router 116.

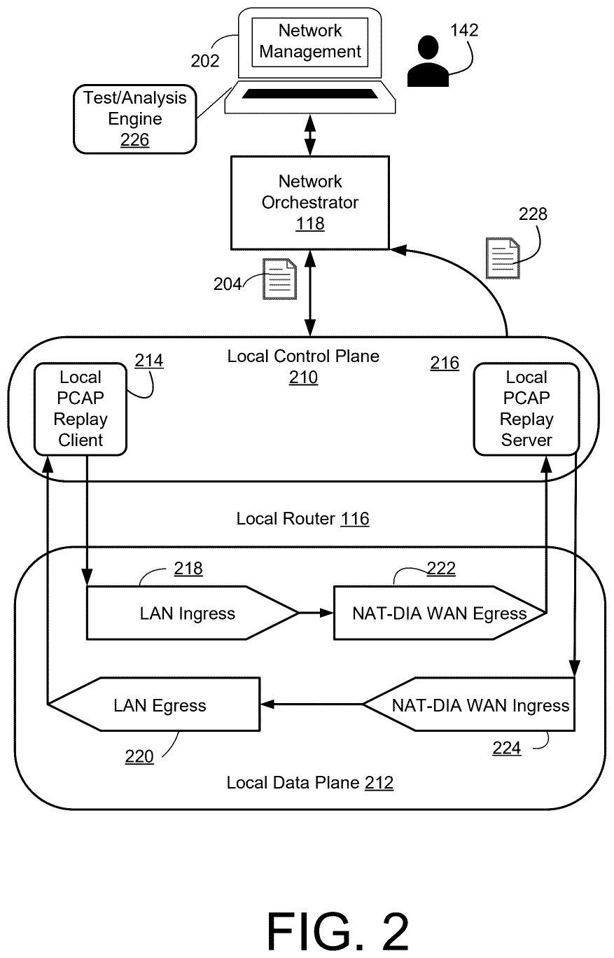

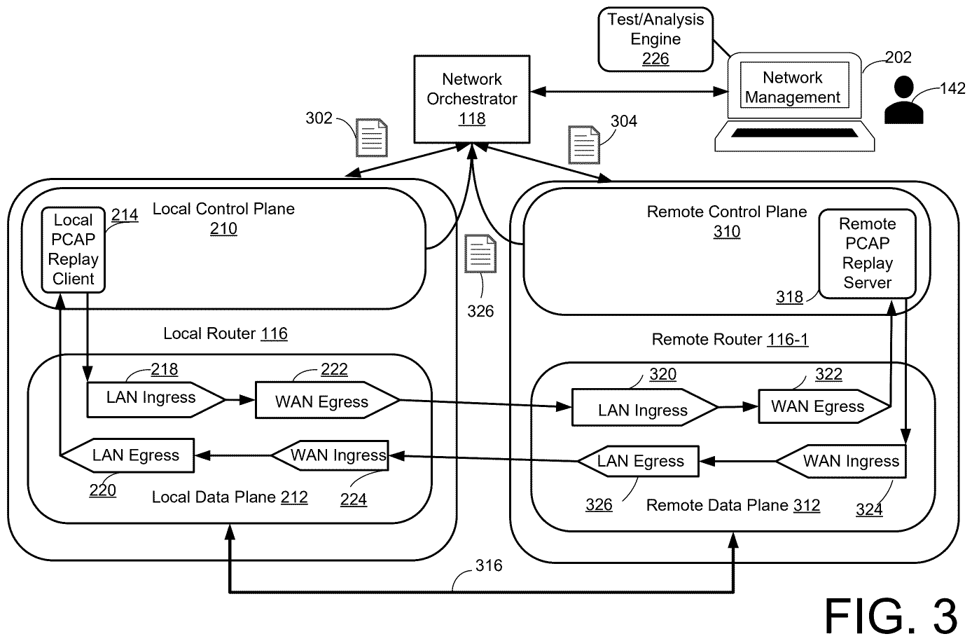

As will be described below with reference to FIGS. 2 and 3, the router 116 may include software-defined client applications and server applications that may be used to process self-contained PCAP replay as described herein. According to examples of the present disclosure, the router 116 may enable a number of network resources in association with a user's computing devices or systems 104 (106-112). Network resources enabled by the router 116 may be associated with one or more network resource identities including but not limited to particular users, user locations, network services, network services locations, network routing protocols, network security protocols, Internet Protocol (IP) addresses associated with network resources, communications interfaces, communications interfaces, network slices, and the like. As understood by those skilled in the art, network resources may include one or more interfaces with which a user's computing devices or systems 104 (106-112) communicate with each other and across the network 100. Network resources may also include a number of other resources including but not limited to software-enabled systems associated with the user's computing devices and systems 104 (106-112) such as data security systems, data throughput monitoring systems, and the like.

Examples of network resources include but are not limited to one or more wired, wireless and software-defined interfaces that may be provisioned on routers 116 and that may be employed to direct how data traffic will flow from the user's computing devices or systems 104 (106-112) through the router 116 and out to other computing systems or devices. With such interfaces, routing of communications from one router 116 to another router 116 may be directed. For example, a user 140 may employ a Virtual Private Network (VPN) for providing encrypted communications to and from the user's computing devices or systems 104 (106-112) across a network 100 to and from other users 140 in other homes, facilities and locations via routers 116. Other network resources may include protocols that direct attributes of communications including data throughput, data security information, data quality of service (QoS), and the like.

Other examples of network resources may include customer facing provider-edge (PE) interfaces and provider-edge (PE) to customer-edge (CE) interfaces. Such interfaces may provide routing targets information, route descriptors, pseudo wire (PW) setups, VPN setups and management, virtual routing and forwarding (VRF) interfaces that provide for multiple routing configurations on a single router 116, and the like. Additional examples may include PE-CE peering protocols, QoS policies, segment routing traffic engineering (SR-TE) templates and policies, border gateway protocols (BGP) that provide for inter domain routing, network resource partitions (NRP), streaming telemetry paths, and the like. That is, as understood by those skilled in the art, a vast number of router resource objects may be provisioned on routers 116 for enabling user-required or user-defined network resources for setting up virtual networking systems, for directing how communications will be routed across a network and for monitoring performance of communications across a network. As should be appreciated, the foregoing example services and systems are for purposes of example only and are not limiting of other types of router resource objects and associated network resources that may be provisioned on the router 116.

Referring still to FIG. 1, a network orchestrator 118 is illustrative of a device or application that sets up or provisions network systems or devices such as the router 116 and switch 114 for processing and delivering requests and objectives of a requesting user 140 (or network personnel 142 as described below). For example, if a user 140 requires data transport such as data from electronic mail services to be operated according to a desired data throughput (e.g., data transport speeds, data transport latency, data transport bandwidth, data packet loss levels, data throughput, data transport security information, and the like), the network orchestrator 118 may provision the router 116 with router resource objects that manage network resources including router resource objects (described above) responsible for the user's data services via the router 116.

According to examples of the present disclosure, and as described below, the network orchestrator 118 may provision PCAP files 204 to a router 116 for performing self-contained PCAP replay in an “on box” configuration where client server interaction is performed on a single router 116. Alternatively, the network orchestrator 118 may provision PCAP files 204 for performing network-wide site-to-site PCAP replay between a client located on one router 116 and a server located on a second router 116.

FIG. 2 illustrates a system architecture for mimicking user traffic through components of a network via a Direct Internet Access (DIA) data transport to facilitate network testing, trouble shooting, network design/pre-test, and network implementation. As illustrated in FIG. 2, a network management system 202 is in communication with the network orchestrator 118 and the router 116. According to examples, network personnel 142 may utilize the network management system 202 for interacting with, controlling, and managing functionalities of the network orchestrator 118 and the router 116 for PCAP file replay and testing as described herein. The network management system 202 may include a cloud-based platform that allows network personnel 142 to manage Software-Defined Wide Area Networks (SD-WAN) as a centralized interface for configuring, monitoring, and troubleshooting SD-WAN devices and systems. In addition to other functions, the network management system 202 may be utilized to distribute PCAP files to either the client or server functionality operating in the control plane of the router as described herein for mimicking the client and server processing of data contained in the PCAP files. Following testing and analysis of data contained in the PCAP files by replaying the PCAP files for network testing, trouble shooting, network design/pre-test, and network implementation, the network management system 202 may be utilized to provide testing and analysis data and insights for a tested PCAP file to network personnel 142. According to one example, the network management system 202 may include the CISCO CATALYST SD-WAN MANAGER (formerly vMANAGE) from CISCO® Systems, Inc. of San Jose, California.

According to examples of the present disclosure, network personnel 142 and/or automated systems operated by the network management system 202 or network orchestrator 118 may designate a PCAP file 204 for testing and/or analysis via a self-contained SD-WAN test at the router 116. The data contained in the PCAP file 204 may be tagged with metadata that will direct testing and analysis as described herein. According to one example, the metadata applied to data contained in the PCAP file 204 will designate an Internet protocol (IP) address for a local PCAP replay client 214 and the local PCAP replay server 216 (described below) at which the PCAP file 204 will be processed.

Referring still to FIG. 2, the router 116 may include a local control plane 210 and a local data plane 212. As understood by those skilled in the art, the local control plane 210 is operative to manage how data is routed and forwarded through the router 116 and across the network 100 by defining rules and paths for data transmission. The local data plane 212 provides pathways in the router 116 for actually moving data packets through the router 116 according to instructions from the local control plane 210.

According to examples, the local control plane 210 may include a software enabled local PCAP replay client 214 and a local PCAP replay server 216. According to examples, local PCAP replay client 214 includes sufficient computer executable instructions for mimicking operation of a client application, service, or network resource. The local PCAP replay server 216 includes sufficient computer executable instructions for mimicking operation of a server at which data may be stored or processed. According to this example, the local PCAP replay client 214 and a local PCAP replay server 216 may be co-located at the same router 116.

The software enabled local PCAP replay client 214 is operative to play or run captured data packet streams contained in a PCAP file 204 for testing the captured data packet streams for network testing, trouble shooting, network design/pre-test, and network implementation, including for one or more problems such as packet loss or inclusion of malicious or otherwise undesired data. According to examples, the local PCAP replay client 214 mimics operation of a client application, service, or network resource, for example, software-enabled systems associated with the user's computing devices and systems 104 (106-112) such as data security systems, data throughput monitoring systems, and the like as illustrated and described above with reference to FIG. 1.

The local PCAP replay server 216 mimics operation of a server at which data from a client application, service, or network resource may be stored or processed. As will be described in detail below, according to examples of the present disclosure, captured data packet streams may be passed from the local PCAP replay client 214 to the local PCAP replay server 216 via the local data plane 212 to mimic data traffic from a client application, service, or network resource to a server at which the data packet stream may be processed internal to the router 116 without the need to utilize external data packet analysis or testing. That is, the captured data packet stream may be analyzed and tested as a self-contained test internal to the router 116.

According to examples, a number of different local PCAP replay clients and/or PCAP replay servers may be provided in the local control plane 210 for testing and analyzing different aspects or features of the PCAP file 204. For example, different local PCAP replay clients 214 and local PCAP replay servers 216 may be utilized for detecting data packet loss, security service concerns, etc. In addition, different local PCAP replay clients and local PCAP replay servers 216 may be utilized to mimic different applications, services and/or network resources to allow self-contained testing according to different systems. For example, the different versions of the local PCAP replay client 214 may simulate operation of different applications, services and/or network resources, and the different versions of the local PCAP replay server 216 may simulate different server processes including data storage, data processing, data transmission, and the like.

Referring still to FIG. 2, data stream flow paths from the local PCAP replay client 214 to and from the local PCAP replay server 216 are provided. According to examples, data contained in the PCAP file 204 may be passed to the router 116 from the network orchestrator 118 where the PCAP file 204 contains data packets and network data flows to be tested and/or analyzed is received by the local PCAP replay client 214 and is passed through the local data plane 212 to the local PCAP replay server 216. After receipt by the local PCAP replay server 216, a responsive data packet flow is passed from the local PCAP replay server 216 back to the local PCAP replay client 214 via the local data plane 212. Thus, a bidirectional data flow passes to and from the local PCAP replay client 214 and the local PCAP replay server 216 in the same manner as a bidirectional data flow may occur between a client application, service or network resource and a separate or remote server. According to examples, this self-contained bidirectional data flow internal to the router 116 allows for the contents of the data flow contained in the PCAP file 204 to be tested and analyzed without leaving the confines of the router 116.

According to examples, the data flow paths provided in the local data plane 212 are provided for data ingress from the local PCAP replay client 214 to the local data plane 212 and egress out the local data plane 212 to the local PCAP replay server 216 and vice versa to provide for bidirectional data flow between the local PCAP replay client and the local PCAP replay server. As understood by those skilled in the art, network ingress is a process of data entering the network, and network egress is a process of data leaving a network. According to examples of the present disclosure, data ingress includes passing data from the local PCAP replay client into the local data plane 212, and data egress includes passing data from the local data plane 212 to the local PCAP replay server 216. When data is passed back from the local PCAP replay server 216, data ingress includes passing data from the local PCAP replay server 216 into the local data plane 212, and data egress includes passing data from the local PCAP replay server 216 out of the local data plane 212 back to the local PCAP replay client 214.

The data flow paths utilized in the local data plane 212 may include a local area network (LAN) ingress path 218 through which the PCAP file 204 is passed from the local PCAP replay client 214 bound for the local PCAP replay server 216. A Network Address Translation Direct Internet Access Wide Area Network (NAT-DIA WAN) egress path 222 is provided for passing the PCAP file 204 out of the local data plane 212 and to the local PCAP replay server 216. As understood by those skilled in the art, Network Address Translation (NAT) allows for multiple devices on a network to share a single IP address. In this case, NAT allows for the local PCAP replay server 216 to be addressed to receive data flows from the local PCAP replay client 214 associated with any number of data flows that may pass to the local PCAP replay client 214. Thus, passage of the data contained in the PCAP file 204 via the LAN ingress path 218 and the NAT-DIA WAN egress path 222 allows for simulation of a flow of the PCAP file 204 from an application, service, or network resource to a separate or remote server available to the LAN application, service, network resource via a Wide Area Network (WAN) at which the PCAP file 204 may be stored or processed without requiring the PCAP file 204 to leave the router 116 for testing and/or analyzing the PCAP file 204. On the bidirectional return, data flow from the local PCAP replay server 216 back to the local PCAP replay client 214, the data flow passes into the local data plane 212 through the NAT-DIA WAN ingress path 224 and out of the local data plane 212 to the local PCAP replay client 214 via the LAN egress path 220.

According to examples, the bidirectional data flow between the local PCAP replay client 214 and the local PCAP replay server 216 provides for a ping-pong interaction between the local PCAP replay client 214 and the local PCAP replay server 216. As understood by those skilled in the art, a ping-pong interaction includes a back-and-forth data flow between the local PCAP replay client 214 and the local PCAP replay server 216. According to examples of the present disclosure, the ping-pong interaction may be repeated iteratively if desired for testing data packet flow via the PCAP file 204 through multiple passes to and from the local PCAP replay client 214 and the local PCAP replay server 216.

Referring still to FIG. 2, a test/analysis engine 226 may be provided in or in association with the network management system 202 for parsing data from the PCAP file and for analyzing the processing of the PCAP file 204 as data contained in the PCAP file is passed bidirectionally between the local PCAP replay client 214 and the local PCAP replay server 216. According to examples, the test/analysis engine 226 may include sufficient computer executable instructions for analyzing the processing of the PCAP file 204 for one or more specified issues. For example, the data contained in the PCAP file 204 may be analyzed for missing data packets. For another example, the data contained in the PCAP file 204 may be analyzed for undesired or malicious content. In addition, the performance of the router 116 or components contained therein may be tested for determining whether any type of packet loss or data corruption occurs during the bidirectional processing of the PCAP file 204. Similarly, operation and performance of the local PCAP replay client 214 and the local PCAP replay server 216 may be tested by determining whether data packet loss, data corruption or other processing issues occur when the data contained in the PCAP file 204 is processed through the local PCAP replay client 214 and local PCAP replay server 216. As will be described further below, the data contained in the PCAP file 204 may annotated with metadata for directing testing and analysis processing of the data contained in the PCAP file 204 and for identifying the data contained in the PCAP file 204 relative to other PCAP files that may be processed, as described herein. In so doing, operating performance of the local PCAP replay client 214 associated with a desired client application, service or network resource mimicked by the local PCAP replay client 214 and the local PCAP replay server 216 may be tested. Likewise, operating performance of the local PCAP replay server 216 that mimics one or more functions of a server to which a data flow may be passed may be mimicked and tested.

According to examples, after testing and/or analyzing the data contained in the PCAP file 204, the test/analysis engine 226 may generate a report 228 that provides testing and/or analysis information for the replayed PCAP file. The report 228 may include SD-WAN insights data, for example, testing and/or analysis data for performance of the local PCAP replay client 214 and the local PCAP replay server 216 in a mimicked SD-WAN environment simulated in the router 116. The report 228 may be passed back to the network orchestrator 118 and back to the network management system 202 for review by systems of the network management system 202 and/or by network personnel 142.

FIG. 3 illustrates a system architecture for mimicking user traffic through components of a network via a network-wide site-to-site data transport to facilitate network testing, trouble shooting, network design/pre-test, and network implementation. As illustrated in FIG. 3, in order to test operation and performance of client applications, services, and network resources and performance of various components of a network, including servers at which data may be stored, processed, transmitted, and the like in a network-wide site-to-site enabled environment, data contained in a PCAP file 302 is passed from the network orchestrator 118 to the local PCAP replay client 214 of the router 116 to a remote PCAP replay server 318 configured in a remote control pane of a remote router 116-1 via a suitable transport system as described below. Thus, instead of performing a self-contained test of the PCAP file replay in a single router 116, the PCAP file replay can be performed to and from the local router 116 and the remote router 116-1 for testing the replayed PCAP file in a network-wide site-to-site environment. That is, according to the example system architecture illustrated FIG. 3, instead of egressing data contained in the PCAP files from the local PCAP replay client 214 to the local PCAP replay server 216 contained in the same router 116, the data contained in the PCAP file is egressed from the local PCAP replay client 214 of the router 116 to a remote PCAP replay server 318 of the remote router 116-1. Thus, bidirectional ping-pong interaction between the local PCAP replay client 214 of the router 116 and the remote PCAP replay server 318 of the remote router 116-1 is provided where responsive communication from the remote PCAP replay server 318 of the remote router 116-1 is routed back to the local PCAP replay client 214 of the router 116. According to an alternative example, data contained in an alternative PCAP file 304 may be passed from the network orchestrator 118 to the remote PCAP replay server 318 and then to the local PCAP replay client 214 to perform the bidirectional ping-pong interaction starting at the remote router 116-1.

Referring still to FIG. 3, according to examples, the remote router 116-1 includes the same functionalities as the router 116 illustrated and described above with reference to FIG. 2, but the remote router 116-1 is separate or remote from the router 116. According to this example, the remote router 116-1 includes a remote PCAP replay server 318 that mimics operation of a server at which data from a client application, service, or network resource may be stored or processed. According to examples of the present disclosure, captured data packet streams may be passed from the local PCAP replay client 214 to the remote PCAP replay server 318 via the local data plane 212 of the local router 116 and the remote data plane 312 of the remote router 116-1 to mimic data traffic from a client application, service, or network resource of a local router to a server of a remote router at which the data packet stream may be processed internal to the router 116 and remote router 116-1 without the need to utilize external data packet analysis or testing. That is, the captured data packet stream may be analyzed and tested as a self-contained test internal to the router 116 and the remote router 116-1 for performing the test in a network-wide site-to-site environment.

In the remote control plane 310 of the remote router 116-1, a remote PCAP replay server 318 is provided for receiving and processing a PCAP file 302. In this case, the PCAP file 302 passes from the local PCAP replay client 214 through the ingress paths 218 and egress paths 222 to the remote PCAP replay server 318 at the remote router 116-1 via a transport protocol or conduit 316. For example, the transport protocol or conduit 316 may include a virtual private network (VPN) path or similar data transmission fabric or pathway.

At the remote router 116-1, data contained in the PCAP file 302 is routed through the remote data plane 312 of the remote router 116-1. As illustrated in FIG. 3, the data flow paths utilized in the remote data plane 312 may include a local area network (LAN) ingress path 320 through which data contained in the PCAP file 302 is passed from the transport protocol or conduit 316 from the local router 116 bound for the remote PCAP replay server 318 of the remote router 116-1. A Wide Area Network (WAN) egress path 322 is provided for passing the data contained in the PCAP file 302 out of the remote data plane 312 and to the remote PCAP replay server 318. On the bidirectional return, data flow from the remote PCAP replay server 318 of the remote router 116-1 back to the local PCAP replay client 214 of the local router 116, the data flow passes into the remote data plane 312 through the WAN ingress path 324 and out of the remote data plane 312 to the via the LAN egress path 326. The data flow then passes back through the transport protocol or conduit 316 to the local data plane 212 of the local router 116 and then to the local PCAP replay client 214, as described above with reference to FIG. 2. For the network-wide site-to-site environment illustrated in FIG. 3, IP addresses tagged in the data of the PCAP file 302 will cause the data contained in the PCAP file 302 to be routed from the local PCAP replay client 214 to the remote PCAP replay server 318 of the remote router 116-1

As with the local DIA case illustrated and describe with respect to FIG. 2, Referring still to FIG. 2, a test/analysis engine 226-1 may be provided in the remote control plane 310 of the remote router 116-1 for analyzing the processing of the PCAP file 302 as it is passed bidirectionally between the local PCAP replay client 214 and the remote PCAP replay server 318. According to examples, after testing and/or analyzing the processed PCAP file, the test/analysis engine 226 may generate a report 328 that provides testing and/or analysis information for the replayed PCAP file. The report 328 may include SD-WAN insights data, for example, testing and/or analysis data for performance of the local PCAP replay client 214 and the remote PCAP replay server 318 in a mimicked SD-WAN network-wide site-to-site environment. The report 228 may be passed back to the network orchestrator 118 and back to the network management system 202 for review by systems of the network management system 202 and/or by network personnel 142.

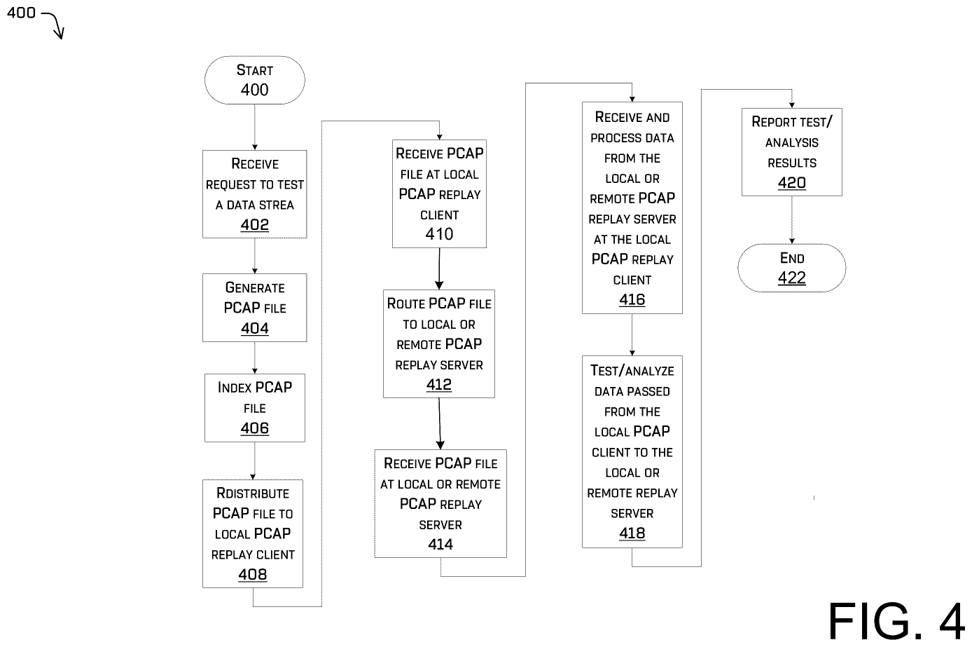

FIG. 4 illustrates a flow diagram of an example method for mimicking user traffic through components of a network via a direct internet access (DIA) data transport or via a network-wide site-to-site data transport to facilitate network testing, trouble shooting, network design/pre-test, and network implementation. The method 400 begins at step 402 and proceeds to step 402 where a manual request is received from network personnel 142 through the network management system 202 or an automated request is received from the network management system 202 to perform a standalone test of a PCAP file 204 in a single local router 116, as illustrated and described with reference to FIG. 2. Alternatively, at step one, the request may be to perform a network-wide site-to-site test of a PCAP file 302 between a single local router 116 and a remote router 116-1. According to examples, the PCAP files 204, 302 may include captured data packet streams for which a test or analysis is desired to determine whether the PCAP files 204, 302 contain missing data packets, malicious or other undesirable content, or the request is made to pass the PCAP files 204, 302 through a testing and analysis system, as described above with reference to FIGS. 2 and 3 to determine the operating performance of one or more components of the network 100, illustrated and described above with reference to FIG. 1. For example, the request may be in response to a notification that a given router is not performing properly where data packets passing through the router 116 or remote router 116-1 are incurring data packet loss as the data packets are passing through one of the router 116 or remote router 116-1.

At step 404, the PCAP file 204 is generated containing one or more data packets that will be used for the requested test and/or analysis. As part of generation of the PCAP file 204, network personnel 142 may manually specify a LAN/client side IP address associated with a local PCAP replay client 214 through which the data contained in the PCAP file 204 will be initially passed, and specifying a WAN/server-side IP address for the local PCAP replay server 216 so that the data contained in the PCAP file 204 may be passed to the local PCAP replay client 214 to begin a bidirectional ping-pong interaction with the local PCAP replay server 216 for testing and analyzing the passage of a data stream contained in the PCAP file 204 through the router 116 for determining operation performance of the router 116 or for testing the data stream contained in the PCAP file 204 for lost packets, presence of malicious or undeserved other undesirable content, and the like. If the request is for a network-wide site-to-site test, then the data contained in the PCAP file 302 may be annotated to specify a LAN/client side IP address associated with a local PCAP replay client 214 through which the PCAP file 302 will be initially passed and specifying a WAN/server-side IP address for the remote PCAP replay server 318.

According to examples, the PCAP files are first sent to the PCAP replay client and to the PCAP replay server where the PCAP files are processed to index the data contained in the PCAP files and to obtain the data contained in the PCAP files for performing the bidirectional ping-pond data flows. In addition to parsing the PCAP files for the data contained in the PCAP files, the data contained in the PCAP files may be tagged with metadata for instructing the processing of the data contained in the PCAP files, as described herein.

That is, by specifying in LAN/client side IP address and a WAN/server side IP address, the data contained in the PCAP file 204 may be routed through the router 116 via the local PCAP replay client 214 and the local PCAP replay server 216 to exactly mimic how a user's direct Internet access traffic may be routed according to configurations and policies set for the router 116 including all input/output features programmed on the router 116 for consumption of data passed through the router 116. In the case of a network-wide site-to-site environment, specifying in LAN/client side IP address for the local PCAP replay client 214 and a WAN/server side IP address for the remote PCAP replay server 318, the data contained in the PCAP file 302 may be routed through the local router 116 to the remote router 116-1 via the local PCAP replay client 214 and the remote PCAP replay server 318 to exactly mimic how a user's site-to-site traffic may be routed according to configurations and policies set for the local router 116 and the remote router 116-1 including all input/output features programmed on the local router 116 and the remote router 116-1 for consumption of data passed through the local router 116 and the remote router 116-1.

As described above with reference to FIG. 2, passing the data contained in the PCAP file 204 through the router 116 via a bidirectional ping-pong interaction between the local PCAP replay client 214 and the local PCAP replay server 216 allows for routing the PCAP file 204 through the components of the router 116 according to routing configurations and policy set for the local router 116 and all input/output features programmed on the local router 116 to consume data contained in the PCAP file 204. That is, as described above with reference to FIG. 2, utilizing the bidirectional ping-pong interaction between the local PCAP replay client 214 and the local PCAP replay server 216 allows for testing and analysis of the data contained in the PCAP file 204 and/or components of the router 116 where the router 116 serves as both a client and server for purposes of testing and/or analyzing the PCAP file 204. According to examples, the data contained in the PCAP file 204 may be indexed as client and server-side messages based on bike sequence offset, client and server-side packets for the desired bidirectional ping-pong interaction. Similarly, as described above with reference to FIG. 3, passing the data contained in the PCAP file 302 through the router 116 and remote router 116-1 via a bidirectional ping-pong interaction between the local PCAP replay client 214 and the remote PCAP replay server 318 allows for routing the data contained in the PCAP file 302 through the components of the local router 116 and the remote router 116-1 according to routing configurations and policy set for the local router 116 and the remote router 116-1, and all input/output features programmed on the local router 116 and the remote router 116-1 to allow the local router 116 and the remote router 116-1 to consume data contained in the data contained in the PCAP file 302.

At step 406, the data contained in the PCAP files 204, 302 may be indexed as client and server side messages based on bite sequence offset to allow client and server-side data packets to follow a bidirectional ping-pong interaction, as described herein. For example, the data contained in the PCAP files 204, 302 may be indexed for the local PCAP replay client 214 with an index of one, three, five, seven, etc., and the data contained in the PCAP file 204, 302 may be index for the local PCAP replay server 216 or the remote PCAP replay server 318 with an index of two, four, six, eight, etc. to distinguish interaction of the data contained in the PCAP files 204, 302 with the local PCAP replay client 214 as opposed to the local PCAP replay server 216 or the remote PCAP replay server 318.

At step 408, the network management system 202 through the network orchestrator 118 distributes the data contained in the PCAP file 204 for a single router DIA case or a PCAP file 302 for a network-wide site-to-site case along with replay configuration information applied to the data contained in the PCAP file 204 or the PCAP file 302. According to one example, replay configuration may include tagging data packets contained in the PCAP file 204 or the PCAP file 302 with metadata that will define and cause the data contained in the PCAP file 204 or the PCAP file 302 to be routed through the router 116 via the local PCAP replay client 214 and local PCAP replay server 216 as described above with reference to FIG. 2, or through the router 116 via the local PCAP replay client 214 and the remote PCAP replay server 318 as described above with reference to FIG. 3.

For the single router DIA case, the data contained in the PCAP file 204 may be tagged with metadata that will cause the data contained in the PCAP file 204 to ping-pong between the local PCAP replay client 214 and the local PCAP replay server 216 a specified number of times or may cause the test/analysis engine 226 to test and/or analyze the PCAP file 204 routed through the router 116 according to one or more requests such as determining whether data contained in the PCAP file 204 contains malicious or other undesired data or for determining whether data contained in the PCAP file 204 has incurred missing data packets, and the like. For the network-wide site-to-site case, the data contained in the PCAP file 302 may be tagged with metadata that will cause the data contained in the PCAP file 302 to ping-pong between the local PCAP replay client 214 and the remote PCAP replay server 318 a specified number of times or may cause the test/analysis engine 226 to test and/or analyze the data contained in the PCAP file 302 routed through the local router 116 and the remote router 116-1 according to one or more requests such as determining whether data contained in the PCAP file 302 contains malicious or other undesired data or for determining whether data contained in the PCAP file 302 has incurred missing data packets, and the like.

At step 410, the data contained in the PCAP file 204 or the PCAP file 302 is received at the local PCAP replay client 214. Based on the tagging and/or metadata applied to the data contained in the PCAP file 204 or the PCAP file 302, the local PCAP replay client 214 replays the data contained in the PCAP file 204 or the PCAP file 302 in the same manner as would occur with user traffic passing through the local router 116. In the single router DIA case, the local PCAP replay client 214 will pass the data contained in the PCAP file 204 through the local data plane 212 to the local PCAP replay server 216 as if the PCAP file 204 includes user traffic passing from an application, service or network resource through the network 100 to a destination server to allow the router 116 to process the data contained in the PCAP file 204 to mimic or simulate how user data traffic would pass from a given application, service, or network resource through a network 102 a server at which the data may be stored and/or processed as desired. In the network-wide site-to-site case, the local PCAP replay client 214 will pass the data contained in the PCAP file 302 through the local data plane 212 to the remote PCAP replay server 318 via the transport protocol or conduit 316 and remote data plane 312 as if the PCAP file 302 includes user traffic passing from an application, service or network resource through the network 100 to a remote destination server to allow the local router 116 and the remote router 116-1 to process the data contained in the PCAP file 302 to mimic or simulate how user data traffic would pass from a given application, service, or network resource through a network 100 to a server at which the data may be stored and/or processed as desired.

At step 412, in the single router DIA case, the data contained in the PCAP file 204 received at the local PCAP replay client 214 passes through the LAN ingress path 218 as an ingress operation into the local data plane 212. The PCAP file 204 passes through the NAT-DIA WAN egress path 222 to the local PCAP replay server 216. In the network-wide site-to-site case, the PCAP file 302 received at the local PCAP replay client 214 passes through the LAN ingress path 218 as an ingress operation into the local data plane 212 and then through the transport protocol or conduit 316 to the remote router 116-1. At the remote router 116-1, the PCAP file 302 passes through the LAN ingress path 320 and WAN egress path 322 to the remote PCAP replay server 318.

At step 414, in the single router DIA case, the data contained in the PCAP file 204 is received at the local PCAP replay server 216 and is stored and/or processed according to the metadata applied to the data contained in the PCAP file 204. The local PCAP replay server 216 passes a responsive message or data back to the local PCAP replay client 214 via the NAT-DIA WAN ingress path 224 and LAN egress path 220, as described above with reference to FIG. 2. In the network-wide site-to-site case, a responsive message or data is passed back to the local PCAP replay client 214 from the remote PCAP replay server 318 via the WAN ingress path 324, the LAN egress path 326, the transport protocol or conduit 316 and back to the local PCAP replay client 214 via the return data paths in the local data plane 212, as described above with reference to FIG. 3.

At step 416, in either the single router DIA case or the network-wide site-to-site case, the local PCAP replay client 214 reads and/or processes the responsive message or data in the same manner as would be performed by an application, service, and/or network resource as defined by the metadata applied to the data contained in the PCAP file 204 or the PCAP file 302. If the data contained in the PCAP file 204 or the PCAP file 302 is tagged with metadata requiring the PCAP file 204 or the PCAP file 302 to iterate according to a bidirectional ping-pong interaction between the local PCAP replay client 214 and the local PCAP replay server 216 or between the local PCAP replay client 214 and the remote PCAP replay server 318, then data in the responsive message or data from the local PCAP replay client 214 will be passed back through the local data plane 212 to the local PCAP replay server 216 or to the remote PCAP replay server 318 for additional processing. For example, if the data contained in the PCAP file 204 or PCAP file 302 has been tagged with metadata associated with an example electronic mail application, the metadata applied to data contained in the PCAP file 204 or PCAP file 302 may cause the local PCAP replay client 214 to pass the data to the local PCAP replay server 216 or to the remote PCAP replay server 318 in the same manner as data, for example, electronic mail messages, may be passed from the example electronic mail application to an electronic mail processing server. According to this example, the PCAP file 204 or PCAP file 302 may include data captured from a user's electronic mail transmission from example electronic mail application to an electronic mail processing server for purposes of testing how electronic mail messages from the electronic mail application are processed as they pass through the local router 116 or remote router 116-1 to a desired electronic mail server.

According to examples of the present disclosure, user traffic emanating from a client application, service and/or network component may be tested and/or analyzed as it passes through a local router 116 or remote router 116-1 to a server by mimicking the user traffic and mimicking operation of the user client application, service, and/or network component via the local PCAP replay client 214 and the local PCAP replay server 216 or via the local PCAP replay client 214 and the remote PCAP replay server 318. Accordingly, the user traffic and/or operation of network components through which the user traffic passes may be tested and/or analyzed at the local router 116 or remote router 116-1 without the need for exposing the user traffic to outside testing services or systems.

At step 418, after the data contained in the PCAP file 204 or PCAP file 302 is bidirectionally passed to and from the local PCAP replay client 214 and the local PCAP replay server 216 or the remote PCAP replay server 318, data associated with routing the PCAP file 204 or the PCAP file 302 or data contained therein is passed to the test/analysis engine 226 for testing and analysis. At the test/analysis engine 226, analysis of data representing the routing of the PCAP file 204 or the PCAP file 302 or data contained therein through the components of the local router 116 or remote router 116-1, as described herein, is tested and/or analyzed according to metadata applied to the data contained in the PCAP file 204 or PCAP file 302. For example, if the original request for passing the data contained in the PCAP file 204 or PCAP file 302 through the local PCAP replay client 214 and then to the local PCAP replay server 216 or to the remote PCAP replay server 318 is to determine whether data packet loss is being incurred in data represented by the PCAP file 204 or PCAP file 302, then the test/analysis engine 226 will compare data could contained in the original PCAP file with data received after the requisite bidirectional ping-pong interaction between the local PCAP replay client 214 and the local PCAP replay server 216 or between the local PCAP replay client 214 and the remote PCAP replay server 318 to determine whether packet loss has been experienced.

According to another example, if the original request for passing the data contained in the PCAP file 204 through the local PCAP replay client 214 to the local PCAP replay server 216 or for passing the data contained in the PCAP file 204 through the local PCAP replay client 214 to the remote PCAP replay server 318 was for determining whether the data captured in the PCAP file 204 or the PCAP file 302 contains malicious or other undesirable data, then the test/analysis engine 226 may review the data passed to it after processing the data through the local router 116 or the remote router 116-1, as described herein, to determine whether any malicious or otherwise undesirable data is contained in the PCAP file 204 or the PCAP file 302. At step 420, based on the testing and/or analysis performed by the test/analysis engine 226, a report 228, 328 is generated for automated analysis and/or for review by network personnel 142.

Thus, as described herein with reference to FIG. 4, the SD-WAN self-contained testing according to the standalone single router DIA system illustrated and described above with reference to FIG. 2 or the network-wide site-to-site system illustrated and described above with reference to FIG. 3 allows for the testing of captured data streams by passing the captured data streams through the local PCAP replay client 214 to the local PCAP replay server 216 or through the local PCAP replay client 214 to the remote PCAP replay server 318 to exactly mimic or simulate how the data captured in the PCAP file 204 or the PCAP file 302 would be processed by a client application, service, and/or network resource before being passed to a server for storage and/or other processing. The method 400 ends at step 422.

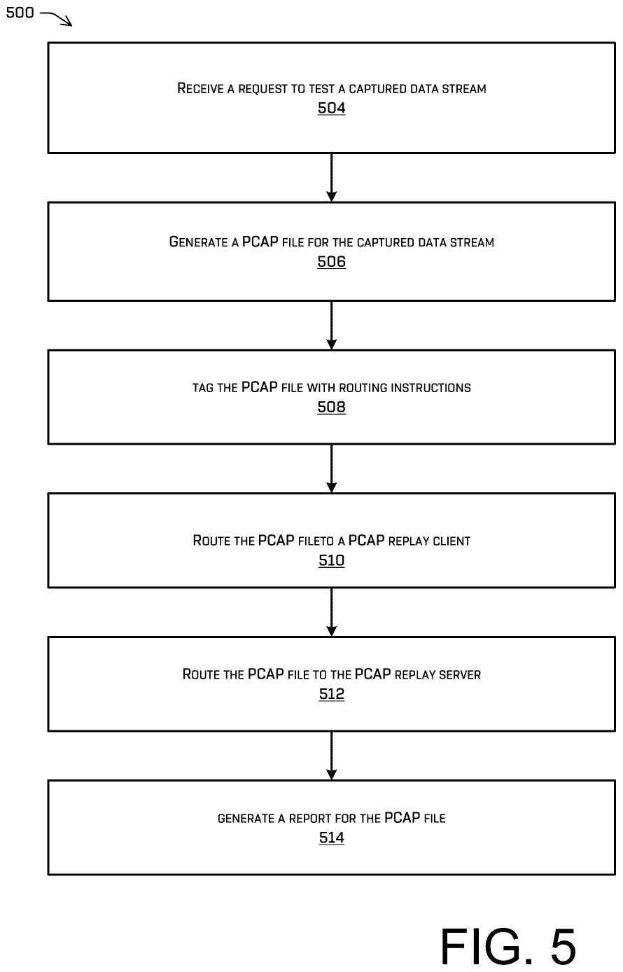

FIG. 5 illustrates a flow diagram of an example method for mimicking user traffic through components of a network to facilitate network testing, trouble shooting, network design/pre-test, and network implementation. The method 500 begins at operation 504 where a request is received to test a captured data stream. Receiving a request to test a captured data stream includes receiving a request to test the captured data stream via a standalone Direct Internet Access (DIA) single router. Alternatively, receiving a request to test a captured data stream includes receiving a request to test the captured data stream via a network-wide site-to-site environment. The PCAP replay client is located at a first router within the network-wide site-to-site environment, and the PCAP replay server being located at a second router within the network-wide site-to-site environment. Routing the data contained in the PCAP file from the PCAP replay client to the PCAP replay server includes routing the data contained in the PCAP file from the PCAP replay client to the PCAP replay server via a virtual private network (VPN). After the data contained in the PCAP file is routed to the PCAP replay server, the data contained in the PCAP file is routed from the PCAP replay server back to the PCAP replay client.
At operation 506, a packet capture (PCAP) file containing the captured data stream is generated.
At operation 508, the data contained in the PCAP file is tagged with one or more routing instructions. Tagging the data contained in the PCAP file with one or more routing instructions includes tagging the data contained in the PCAP file with an Internet Protocol (IP) address associated with the router based PCAP replay client. Tagging the data contained in the PCAP file with one or more routing instructions includes tagging the PCAP file with an IP address associated with the PCAP replay server; the PCAP server being co-located with the router based PCAP replay client.
At operation 510, the data contained in the PCAP file is routed to a router based PCAP replay client based on the one or more routing instructions. The data contained in the PCAP file is received at the router based PCAP replay client. At the router based PCAP replay client, the data contained in the PCAP file is read and routing instructions are determined for the PCAP file.
At operation 512, the data contained in the PCAP file is routed from the PCAP replay client to a PCAP replay server. Determining routing instructions for the PCAP file includes determining an IP address associated with the PCAP replay server. After routing the data contained in the PCAP file from the PCAP replay client to the PCAP replay server, the data contained in the PCAP file is received at the PCAP replay server.
At operation 514, a report is generated describing a result of routing the data contained in the PCAP file from the PCAP replay client to the PCAP replay server. Generating a report describing a result of routing the data contained in the PCAP file from the PCAP replay client to the PCAP replay server includes generating a report describing a condition of data contained in the PCAP file after the PCAP file is routed from the PCAP replay client to the PCAP replay server. Generating a report describing a result of routing the data contained in the PCAP file from the PCAP replay client to the PCAP replay server includes generating a report at a test application.

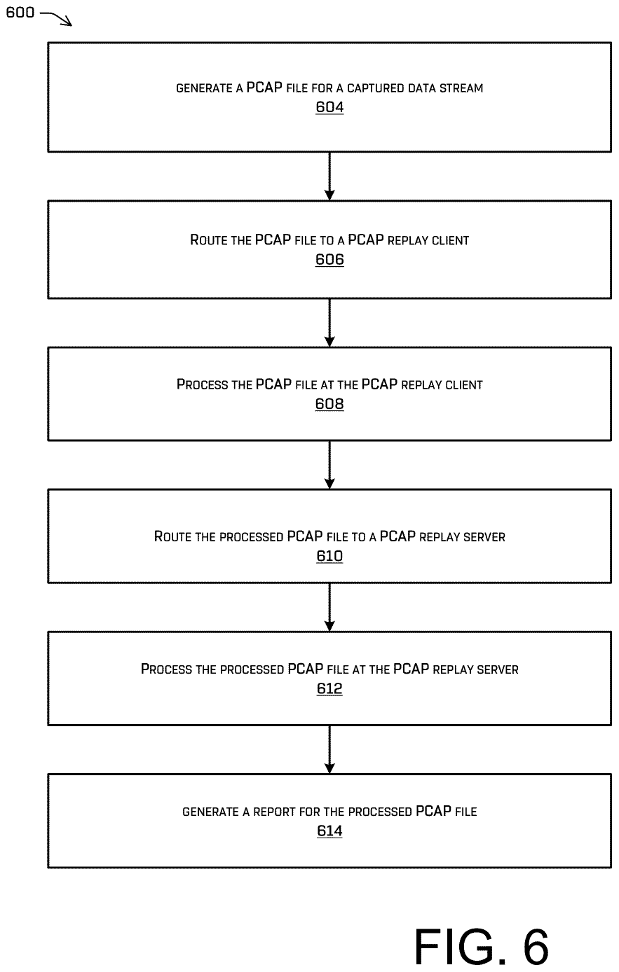

FIG. 6 illustrates a flow diagram of an example method for mimicking user traffic through components of a network to facilitate network testing, trouble shooting, network design/pre-test, and network implementation. The method 600 begins at operation 604 where a packet capture (PCAP) file is generated containing a captured data stream from a prior data operation. At operation 606, the data contained in the PCAP file is routed to a PCAP replay client at a network router. According to examples, the PCAP replay client and the PCAP replay server are co-located at the network router. Alternatively, the PCAP replay client is located at a first network router and the PCAP replay server is located at a second network router, and the PCAP replay client is in communication with the PCAP replay server from the first network router to the second network router via a virtual private network (VPN).

Prior to routing the data contained in the PCAP file to a PCAP replay client at a network router, the data contained in the PCAP file is tagged with one or more routing instructions. The data contained in the PCAP file is routed to a PCAP replay client at a network router based on the one or more routing instructions. The data contained in the PCAP file is routed from the PCAP replay client to a PCAP replay server based on the one or more routing instructions. According to examples, the data contained in the PCAP file is routed to a PCAP replay client at a network router based on the one or more routing instructions includes routing the PCAP file to the PCAP replay client based on an Internet Protocol (IP) address associated with the PCAP replay client, and the data contained in the PCAP file is routed from the PCAP replay client to the PCAP replay server based on the one or more routing instructions includes routing the data contained in the PCAP file to the PCAP replay server based on an IP address associated with the PCAP replay server.

At operation 608, the data contained in the PCAP file is processed at the PCAP replay client according to the prior data operation. At operation 610, after processing the data contained in the PCAP file at the PCAP replay client, the processed data contained in the PCAP file is routed to a PCAP replay server. At operation 612, the processed data contained in the PCAP file is processed according to the prior data operation. At operation 614, a report is generated describing a result of processing the PCAP file at the PCAP replay client and at the PCAP replay server according to the prior data operation.

FIG. 7 is a computer architecture diagram showing an illustrative computer hardware architecture for implementing a computing system/device that can be utilized to implement aspects of the various technologies presented herein. The computer architecture shown in FIG. 7 illustrates any type of computer 700, such as a conventional server computer, workstation, desktop computer, laptop, tablet, network appliance, e-reader, smartphone, or other computing device, and can be utilized to execute any of the software components presented herein. The computer may, in some examples, correspond to a client computing systems and devices 104-112 as illustrated in FIGS. 1 and 2 and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 700 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the computer 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the computer 700. The chipset 706 can further provide an interface to a computer-readable storage medium such as a read-only memory (“ROM”) 710 or non-volatile RAM (“NVRAM”) for storing basic routines that help to start up the computer 700 and to transfer information between the various components and devices. The ROM 710 or NVRAM can also store other software components necessary for the operation of the computer 700 in accordance with the configurations described herein.

The computer 700 can operate in a networked environment using logical connections to remote computing devices and computer systems through a network, such as the networks 100, 200. The chipset 706 can include functionality for providing network connectivity through a NIC 712, such as a gigabit Ethernet adapter. The NIC 712 is capable of connecting the computer 700 to other computing devices over the network 724. It should be appreciated that multiple NICs 712 can be present in the computer 700, connecting the computer to other types of networks and remote computer systems.

The computer 700 can be connected to a storage device 718 that provides non-volatile storage for the computer. The storage device 718 can store an operating system 720, programs 722, and data, which have been described in greater detail herein. The storage device 718 can be connected to the computer 700 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 700 can store data on the storage device 718 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 718 is characterized as primary or secondary storage, and the like.

For example, the computer 700 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 700 can further read information from the storage device 718 by detecting the physical states or characteristics of one or more particular locations within the physical storage units.

In addition to the storage device 718 described above, the computer 700 can have access to other computer-readable storage media to store and retrieve information, such as program components, data structures, or other data. It should be appreciated by those skilled in the art that computer-readable storage media is any available media that provides for the non-transitory storage of data and that can be accessed by the computer 700. In some examples, the operations performed by the computing systems and devices 104-112, and or any components included therein, may be supported by one or more devices similar to computer 700. Stated otherwise, some or all of the operations performed by the computing systems and devices 104-112, and or any components included therein, may be performed by one or more computer devices.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the computer 700. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 718 can store other system or application programs and data utilized by the computer 700.

In one embodiment, the storage device 718 or other computer-readable storage media is encoded with computer-executable instructions which, when loaded into the computer 700, transform the computer from a general-purpose computing system into a special-purpose computer capable of implementing the embodiments described herein. These computer-executable instructions transform the computer 700 by specifying how the CPUs 704 transition between states, as described above. According to one embodiment, the computer 700 has access to computer-readable storage media storing computer-executable instructions which, when executed by the computer 700, perform the various processes described above with regard to FIGS. 1-6. The computer 700 can also include computer-readable storage media having instructions stored thereupon for performing any of the other computer-implemented operations described herein.

The computer 700 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat panel display, a digital projector, a printer, or other type of output device. It will be appreciated that the computer 700 might not include all of the components shown in FIG. 7, can include other components that are not explicitly shown in FIG. 7, or might utilize an architecture completely different than that shown in FIG. 7.

The computer 700 may include one or more CPUs 704 (i.e., processors) configured to execute one or more stored instructions. The CPUs 704 may comprise one or more cores. The router resource objects may include devices configured to couple to personal area networks (PANs), wired and wireless local area networks (LANs), wired and wireless wide area networks (WANs), and so forth. For example, the router resource objects may include devices compatible with Ethernet, Wi-Fi™, and so forth. The programs 722 may comprise any type of programs or processes to perform the techniques described in this disclosure for utilization of contextual metadata for identifying network operation telemetry or event log data.

While the invention is described with respect to the specific examples, it is to be understood that the scope of the invention is not limited to these specific examples. Since other modifications and changes varied to fit operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method, comprising:
receiving a request to test a captured data stream;
generating a PCAP file containing the captured data stream;
tagging data contained in the PCAP file with one or more routing instructions;
routing the data contained in the PCAP file to a PCAP replay client based on the one or more routing instructions;
routing the data contained in the PCAP file from the PCAP replay client to a PCAP replay server; and
generating a report describing a result of routing the data contained in the PCAP file from the PCAP replay client to the PCAP replay server.

2. The method of claim 1,
wherein tagging the data contained in the PCAP file with one or more routing instructions includes tagging the data contained in the PCAP file with an Internet Protocol (IP) address associated with the PCAP replay client; and
wherein tagging the data contained in the PCAP file with one or more routing instructions includes tagging the data contained in the PCAP file with an IP address associated with the PCAP replay server; the PCAP replay server being co-located with the PCAP replay client.

3. The method of claim 2,
wherein receiving a request to test a captured data stream includes receiving a request to test the captured data stream via a Direct Internet Access (DIA) single router.

4. The method of claim 1,
wherein tagging the data contained in the PCAP file with one or more routing instructions includes tagging the data contained in the PCAP file with an Internet Protocol (IP) address associated with the PCAP replay client; and
wherein tagging the data contained in the PCAP file with one or more routing instructions includes tagging the PCAP file with an IP address associated with the PCAP replay server; the PCAP replay server being located remotely from the PCAP replay client.

5. The method of claim 4,
wherein receiving a request to test a captured data stream includes receiving a request to test the captured data stream via a network-wide site-to-site environment; the PCAP replay client being located at a first router within the network-wide site-to-site environment, and the PCAP replay server being located at a second router within the network-wide site-to-site environment; and
wherein routing the data contained in the PCAP file from the PCAP replay client to the PCAP replay server includes routing the data contained in the PCAP file from the PCAP replay client to the PCAP replay server via a virtual private network (VPN).

6. The method of claim 1, further comprising:
routing the data contained in the PCAP file from the PCAP replay server back to the PCAP replay client.

7. The method of claim 1,
wherein receiving a request to test the captured data stream includes receiving the request via a network management system.

8. The method of claim 1, further comprising:
receiving the data contained in the PCAP file at the PCAP replay client; and
at the PCAP replay client, determining routing instructions for the PCAP file.

9. The method of claim 8,
wherein determining routing instructions for the data contained in the PCAP file includes determining an IP address associated with the PCAP replay server; and
wherein after routing the data contained in the PCAP file from the PCAP replay client to the PCAP replay server, receiving the data contained in the PCAP file at the PCAP replay server.

10. The method of claim 1, further comprising routing the report to a network management system.

11. The method of claim 1,
wherein generating a report describing a result of routing the data contained in the PCAP file from the PCAP replay client to the PCAP replay server includes generating a report describing the data contained in the PCAP file after the data contained in the PCAP file is routed from the PCAP replay client to the PCAP replay server.

12. The method of claim 11,
wherein generating a report describing a result of routing the data contained in the PCAP file from the PCAP replay client to the PCAP replay server includes generating a report at a test application.

13. The method of claim 1,
wherein routing the data contained in the PCAP file from the PCAP replay client to the PCAP replay server includes routing the data contained in the PCAP file into a router data plane via a Local Area Network (LAN) ingress data path; and
routing the data contained in the PCAP file out of the router data plane and to the PCAP replay server via a Wide Area Network (WAN) egress data path.

14. The method of claim 13,
wherein after routing the data contained in the PCAP file from the PCAP replay client to the PCAP replay server, routing the data contained in the PCAP file back to the PCAP replay client via a WAN ingress path into the router data plane; and
routing the data contained in the PCAP file out of the router data plane and to the PCAP replay client via a LAN egress data path.

15. A method, comprising:
generating a PCAP file containing a captured data stream from a prior data operation;
routing data contained in the PCAP file to a PCAP replay client at a network router;
processing the data contained in the PCAP file at the PCAP replay client according to the prior data operation;
after processing the data contained in the PCAP file at the PCAP replay client, routing the processed data contained in the PCAP file to a PCAP replay server;
at the PCAP replay server, processing the processed data contained in the PCAP file according to the prior data operation; and
generating a report describing a result of processing the data contained in the PCAP file at the PCAP replay client and at the PCAP replay server according to the prior data operation.

16. The method of claim 15, further comprising:
wherein prior to routing the data contained in the PCAP file to a PCAP replay client at a network router, tagging the data contained in the PCAP file with one or more routing instructions;
routing the data contained in the PCAP file to a PCAP replay client at a network router based on the one or more routing instructions; and
routing the data contained in the PCAP file from the PCAP replay client to a PCAP replay server based on the one or more routing instructions.

17. The method of claim 16,
wherein routing the data contained in the PCAP file to a PCAP replay client at a network router based on the one or more routing instructions includes routing the data contained in the PCAP file to the PCAP replay client based on an Internet Protocol (IP) address associated with the PCAP replay client; and
wherein routing the data contained in the PCAP file from the PCAP replay client to the PCAP replay server based on the one or more routing instructions includes routing the data contained in the PCAP file to the PCAP replay server based on an IP address associated with the PCAP replay server.

18. The method of claim 17,
wherein the PCAP replay client and the PCAP replay server are co-located at the network router.

19. The method of claim 17,
wherein the PCAP replay client is located at a first network router and the PCAP replay server is located at a second network router, the PCAP replay client being in communication with the PCAP replay server from the first network router to the second network router via a virtual private network (VPN).

20. A system, comprising:
a network management system operative
to generate a PCAP file containing a captured data stream from a prior data operation;
a network orchestrator operative
to route data contained in the PCAP file to a PCAP replay client at a network router;
the PCAP replay client operative
to process the data contained in the PCAP file at the PCAP replay client according to the prior data operation;
to route the processed data contained in the PCAP file to a PCAP replay server after processing the PCAP file at the PCAP replay client;
the PCAP replay server operative
to process the processed data contained in the PCAP file according to the prior data operation; and
a test and analysis engine operative
to generate a report describing a result of processing the data contained in the PCAP file at the PCAP replay client and at the PCAP replay server according to the prior data operation.
